(19) United States
(12) Patent Application Publication
(10) Pub. No.: US 2010/0051815 A1
(43) Pub. Date: Mar. 4, 2010

(54) HEAT-RADIATING PATTERN

(76) Inventor: Kwangyeol Lee, Namyangju-si (KR)

Correspondence Address: EDWARDS ANGELL PALMER & DODGE LLP, P.O. BOX 55874, BOSTON, MA, 02205, US

(21) Appl. No.: 12/201,809

(22) Filed: Aug. 29, 2008

(51) Int. Cl. G01J 5/02; B32B 3/00; B05D 3/12

(52) U.S. Cl. 250/341.6; 428/209; 427/309

(57) ABSTRACT

A heat-radiating pattern and a heat-radiating pattern includes metal layers such as Au (gold) and Ag (silver). Metal layers with certain dimensions can absorb light in the visible/near IR (infrared) range and emit light in IR range as heat. The metal layers can be formed into a desired pattern and surroundings of the metal layers can be heated up locally and thereby form a portion of the heat-radiating pattern. Locally heated portions on a substrate by the heat-radiating pattern can transform a heat reactive polymer layer and perform as a local heater.

### BACKGROUND

### Description of Related Technology

In a film fabrication, a precursor of the film can be transformed to a film by undergoing a chemical reaction with provided heat. The precursor of the film can transform at a certain range of temperatures. A substrate with the precursor can be heated to the range of temperature to transform the precursor. However, localized or pattern formation of the film with this process is difficult since localized heated portions of the substrate are needed.

### SUMMARY

Some aspects of the present disclosure provide methods of making a heat-radiating pattern. For example, a heat-radiating pattern may include metal layers such as Au (gold), Ag (silver) and etc. Metal layers with certain dimensions can absorb light in the visible/near IR (infrared) range and emit light in the IR range as heat. According to some aspects of the present disclosure, the metal layers can be deposited in a desired pattern heated locally to transform a heat reactive layer formed on the heat radiating pattern.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 shows schematics of an illustrative embodiment of a process of making a heat-radiating pattern.

FIG. 2 shows schematics of an illustrative embodiment of layers in a heat-radiating pattern.

FIG. 3A shows schematics of an illustrative embodiment of a heat-radiating pattern undergoing a light emission process.

FIG. 3B shows schematics of an illustrative embodiment of heat radiated from a heat-radiating pattern.

FIGS. 4A and 4B show schematics of an illustrative embodiment of polymer layers transformed with heat from a heat-radiating pattern.

FIG. 5 shows schematics of an illustrative embodiment of a metal pattern formed on top of a plurality of protrusions.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, and systems related to heat radiating patterns.

Some aspects of the present disclosure provide a heat-radiating pattern. For example, the heat-radiating pattern may include metal layers such as Au (gold), Ag (silver) and etc. Metal layers with certain dimensions can absorb light in the visible/near IR (infrared) range and emit light in the IR range as heat. According to some aspects of the present disclosure, the metal layers can be deposited in a desired pattern and heated locally to form a portion of the heat-radiating pattern. The heat-radiating pattern can transform a heat reactive layer and perform as a local heater.

Other aspects of the present disclosure relates to methods of making a heat-radiating pattern. The methods include forming a metal layer including one or more metal nanoparticles forming a pattern, forming a transparent heat-conducting layer on top of the metal layer, and forming a heat insulating material on the substrate but not above the pattern.

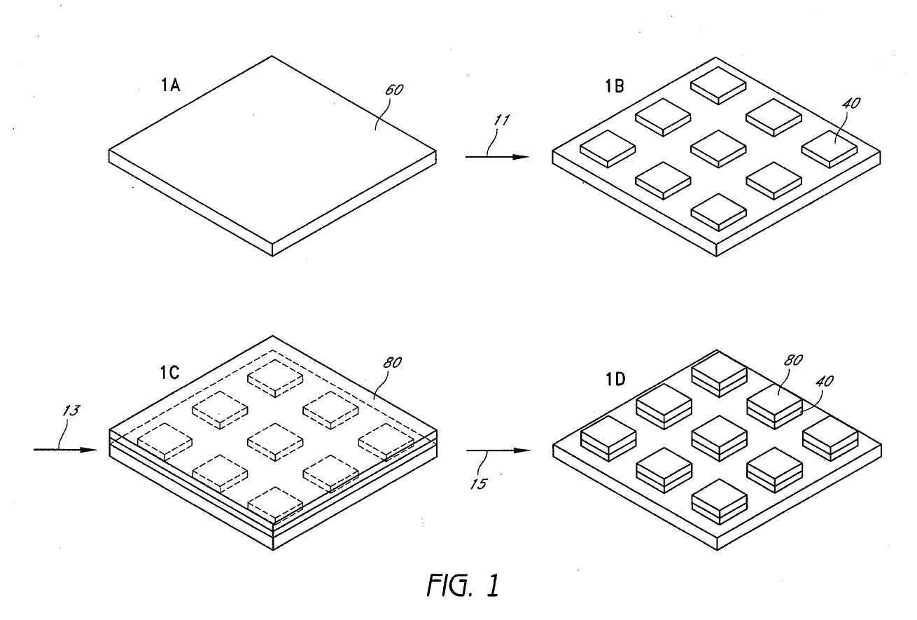

FIG. 1 shows schematics of an illustrative embodiment of method of making a heat-radiating pattern. A substrate 60 is provided. In some embodiments, the substrate 60 can be composed of dielectric material, such as silica, or the substrate 60 can be made from a material with a positive dielectric constant. In other embodiments, if the substrate 60 is composed of non-dielectric material, the substrate 60 is coated with a dielectric material. A metal layer forming a pattern or metal pattern 40 can include one or more metal nanoparticles. The metal nanoparticles form the metal layer 40. In some embodiments, the metal nanoparticles can have a diameter from about 1 nm to about 100 nm. In one such embodiment, the metal nanoparticles have a diameter from about 2 nm to about 4 nm. Generally, a thickness of the metal layer 40 is smaller than a width and/or a length of the metal layer 40. In some embodiments, the thickness of the metal layer 40 can be from about 1 nm to about 200 nm, such as from about 10 nm to about 50 nm. In some embodiments, the width and length of the metal layer 40 can be in general between about 100 nm to about 2,000 nm. In one embodiment, the width and length of the metal layer 40 is from about 200 nm to about 1,000 nm. The metal pattern 40 can be formed above the substrate 60 during a metal pattern formation process 11. In some embodiments, the metal pattern 40 can be composed of Au (gold), Ag (silver), copper, and titanium. In one embodiment, the metal pattern 40 can be formed by depositing a metal layer on the substrate 60 followed by a standard photolithography process. A polymer layer or plastic layer 80 can be applied on top of the metal pattern 40 during a polymer layer deposition process 13. In some embodiments, the polymer 80 can be heat-reactive. In one such embodiment, the polymer layer 80 can be composed of heat curable resists, such as benzyl methacrylate or cyclohexyl acrylate. The polymer layer 80 can be a precursor to a polymer pattern formed above the pattern 20 from heat radiated from the metal pattern 40. In some embodiments, the polymer layer 80 can be composed of polymer material used in flexible display screen, such as PMMA (Polymethyl methacrylate). In some embodiments, the thickness of the polymer layer 80 can be from about 5 nm to about 50 nm. The metal pattern 40 can radiate heat after light is applied to the heat-radiating pattern during a light emission process 15. In some embodiments, an optical fiber can be configured to provide light to the metal pattern 40. The light applied to the heat-radiating pattern can have a frequency range in the IR range, the visible, and/or near IR range. The polymer layer 80 can be at least partially melted or cured from the heat radiating from the heat radiating pattern. In one embodiment, some portions of the polymer layer 80 can be cured on top of the heat radiating pattern and the uncured portions of the polymer layer 80 can be removed.

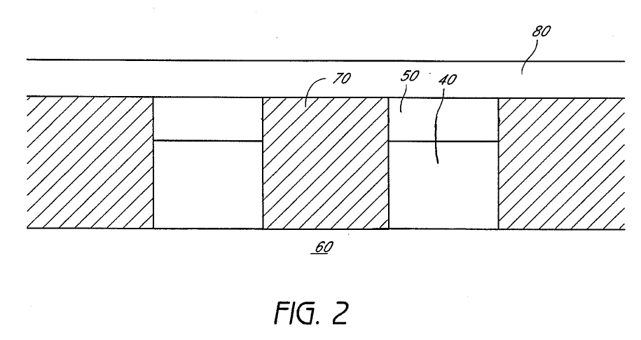

FIG. 2 shows schematics of an illustrative embodiment of formed layers in the heat-radiating pattern. In the illustrative embodiment, the metal pattern 40 can be deposited on the substrate 60. The metal pattern 40 can be formed using techniques, such as metal sputtering, ALD (atomic layer deposition), or other suitable deposition techniques. In some embodiments, a thickness of the metal pattern 40 can be from about 1 nm to about 100 nm. In one such embodiment, the thickness of the metal pattern 40 can be from 3 nm to 20 nm. The deposited metal layer can then be patterned using standard photolithographic processes.

In the illustrative embodiment, a transparent heat-conducting layer 50 can be deposited on top of the metal pattern 40 to form a stack of metal pattern 40 and transparent heat-conducting layer 50. The transparent heat-conducting layer 50 can be composed of doped metal oxide materials, such as ITO (indium tin oxide), F-doped SnO₂, or any other doped metal oxide capable of forming a transparent heat-conducting layer. In some embodiments, a thickness of the transparent heat-conducting layer 50 can be from about 5 nm to about 100 nm. In one such embodiment, the thickness of the transparent heat-conducting layer 50 can be from about 20 nm to about 50 nm. The transparent heat-conducting layer 50 can be transparent to light in the IR range. Thus, the transparent heat-conducting layer 50 can be heat conductive to facilitate transfer of heat radiating away from the metal pattern 40. The transparent heat-conducting layer 50 can be relatively harder than the metal pattern 40 and can provide protection for the metal pattern 40.

A heat insulating material 70 can be deposited to fill openings formed between the portions of layers on the substrate 60. In some embodiments, the heat insulating material 70 does not extend above the metal pattern 40. In some embodiments, the heat insulating material can include metal oxides, such as magnesium oxide, zinc oxide, etc. The heat insulating material 70 can be from about 10 times to about 1000 times less heat conductive than the transparent heat-conducting layer 50. In some embodiments, the heat insulating material 70 can be deposited to about a top surface of the transparent heat-conducting layer 50. The heat insulating material 70 can be formed using ALD or other suitable deposition process. In some embodiments, the insulating material 70 can be formed of pnc-Si (porous nanocrystalinne silicon) membranes by some methods of making such membranes. The top surface of the transparent heat-conducting layer 50 and the heat insulating material 70 can be polished to form an even surface. The polishing can be performed using chemical-mechanical polishing (CMP) or other suitable planarization techniques. A polymer or plastic layer 80 can be formed on top of the even surface.

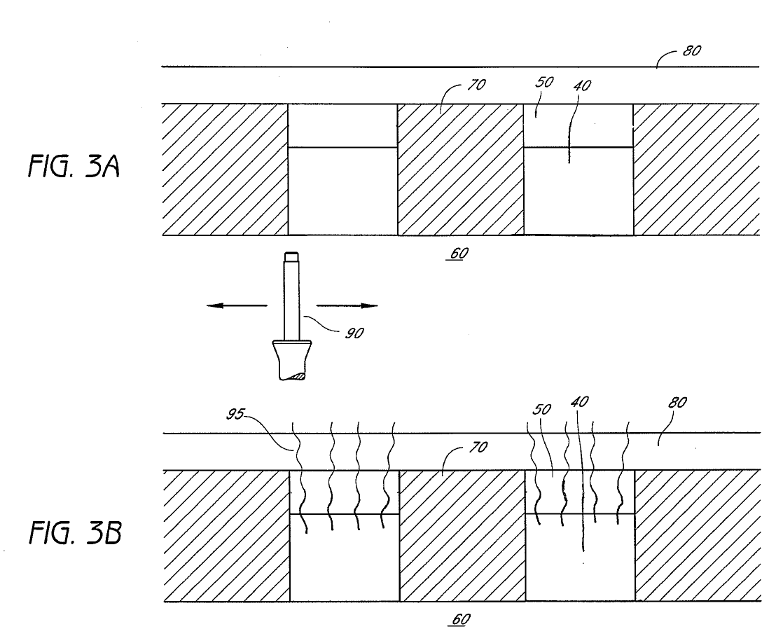

FIG. 3A illustrates an example of a portion of a heat-radiating pattern undergoing the light emission process 15 (of FIG. 1). The light emission process 15 (of FIG. 1) can include applying light to the substrate 60 from a side different from a side with the metal pattern 40. In other embodiments, the light can be applied from the horizontal sides of the substrate 60. The light can be applied from the side with the metal pattern 40 when the polymer layer 80 is composed of transparent material. The light can include light in various wavelength ranges. In one embodiment, the light is in the visible and/or near IR region. In one illustrative embodiment, the light can be produced using a laser 90 producing light with a wavelength ranging from about 300 nm to about 1 mm. In another embodiment, the laser 90 produces light of wavelength ranging from about 500 nm to about 1400 nm. Illustrative embodiments of the laser 90 can have an intensity ranging from about 5 W/cm² to about 50 W/cm². In one embodiment, the intensity ranges from about 10 W/cm² to about 20 W/cm². In some embodiments, the laser 90 can emit light to the metal pattern 40 of the heat-radiating pattern for various durations. For example, the duration can range from about 1 minute to about 100 minutes, such as from about 3 minutes to about 60 minutes. In the illustrative embodiment, the laser 90 can be moved to apply light to different portions of the heat radiating pattern.

FIG. 3B illustrates an example of heat radiated from the portion of the heat-radiating pattern shown in FIG. 3A. In some embodiments, heat 95 can be radiated from the metal pattern 40 by applying light with laser 90 as described above in conjunction with FIG. 3A. For example, the metal pattern 40 gets heated to a temperature ranging from about 10° C. to about 200° C. above that of the surrounding materials or surrounding environment. The heating of the metal pattern 40 can be caused by SPR (surface plasmon resonance) whereby nanostructured metal absorbs light in the visible/near IR range and emits light in the IR range as heat.

In one embodiment, laser 90 is used to illuminate a surface of the metal pattern 40 with light in the visible/near IR range to cause SPR of the metal pattern 40. The metal pattern 40 and the substrate 60, where the substrate 60 can be composed of dielectric material, can provide a metal/dielectric interface needed for surface plasmons to travel. The term surface plasmon can be used to refer to surface electromagnetic waves that propagate in a direction parallel to a metal/dielectric interface. The SPR at the surface of the metal pattern 40 can result in IR radiation or heat 95. For example, SPR of Au nanoparticles can occur with light having a wavelength of about 525 nm applied with duration from about 5 minutes to about 30 minutes. The Au nanoparticles can radiate heat in a range of from about 30° C. to about 50° C. higher than the surrounding.

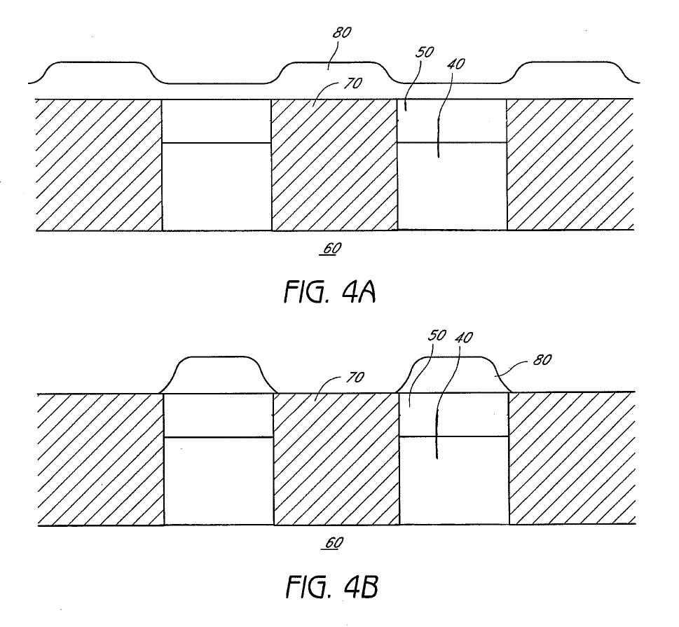

In some embodiments, the heat insulating material 70 can, in effect, direct heat transfer from the metal pattern 40 to surrounding portions where the heat insulating material 70 is not present. In the illustrative example of FIG. 4B, heat insulating material 70 can reduce the amount of heat 95 transferred in a horizontal direction resulting in an increased amount of heat 95 being transferred in a vertical direction. In one embodiment, the heat 95 radiating above the metal pattern 40 can be transferred through the transparent heat-conducting layer 50.

In one embodiment, the heat-radiating pattern can be used to denature DNA. Some portions of the heat-conducting layer 50 can be etched to form one or more micro-wells above the metal layer 40. In some embodiments, the micro-wells can have a volume from about 0.001 mL to about 10 mL, such as from about 0.01 mL to about 1 mL. The DNA samples can be provided on the micro-wells. The heat 95 from the heat-radiating pattern can help separation of the DNA strands to denature the DNA. In other embodiments, the heat 95 can help hybridization of denatured DNA samples. The heat 95 can be radiated by applying light to the heat-radiating pattern.

FIGS. 4A and 4B illustrate examples of polymer layers 80 transformed with heat 95 from a portion of the heat-radiating pattern. As shown in FIG. 4A, in one illustrative embodiment a portion of the polymer layer 80 can be melted using heat radiated from the heat-radiating pattern. The heat can be radiated from the heat-radiating pattern by applying light to the heat-radiating pattern as described above. The heat 95 radiating from the metal pattern 40 can be directed to melt some portions of the polymer layer 80 above the heat-radiating pattern. In one embodiment, the polymer material of the polymer layer 80 melts at a temperature range of about 50° C. to about 200° C.

In one embodiment, the melted portions of the polymer layer 80 can be anti-reflective. The polymer layer 80 can be detached from the heat-radiating pattern and be used in an OLED (organic light emitting diode) device. The polymer layer 80 can include organic plastic material for a conducting or emissive layer in an OLED device.

As shown in FIG. 4B, in one illustrative embodiment some portions of the polymer layer 80 can be cured. Portions of the polymer layer 80 that are not cured can be removed. As shown in FIG. 4B, the heat 95 radiating from the metal pattern 40 can cure the portions of the polymer layer 80 above the heat-radiating pattern. In one embodiment, the polymer material of the polymer layer 80 is cured at a temperature range of about 50° C. to about 200° C. The cured portions of the polymer layer 80 can form the same pattern as the heat-radiating pattern. In one embodiment, the polymer layer 80 with cured portions can be used as a mold in an imprint lithography process.

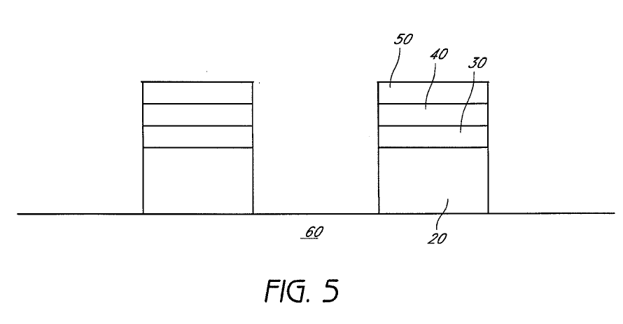

FIG. 5 shows another embodiment of a heat radiating pattern. In this embodiment, protrusions 20 are formed on the substrate 60. In some embodiments, the protrusions 20 can be of various shapes, such as a circle, a triangle, shapes with more than 3 sides, etc.

The materials forming the protrusions 20 are not particularly limited, and can include a variety of materials, such as thermal or UV curable material, polysilicon, silica, silicon nitride, etc. The protrusions 20 can be formed using various suitable techniques, such as LPCVD (low pressure chemical deposition), PECVD (plasma enhanced chemical deposition), ALD, etc. In some embodiments, a standard lithography method can be applied to form a desired pattern of the mask on deposited material for the protrusions 20. Then, the deposited material can be etched away to form the protrusions 20. In some embodiment, the substrate 60 can be applied with the patterned mask and etched to form the protrusions 20.

In some embodiments, the protrusions 20 can have heights from about 10 nm (nanometer) to about 1000 nm and a length from about 10 nm to about 500 nm. In one such embodiment, the protrusions 20 can have a height ranging from about 100 nm to about 500 nm and have a length ranging from about 50 nm to about 200 nm. In one embodiment, the pattern can have varying cross-sections and different heights.

One or more additional layers can be formed on top of the protrusions 20. The additional layers can include at least dielectric layer 30, metal pattern 40, transparent heat-conducting layer 50.

For example, the dielectric layer 30 can be deposited on top of the protrusions 20. The dielectric layer 30 can include SiO₂. In some embodiments, a thickness of the dielectric layer 30 can be from about 10 nm to about 1000 nm. In one such embodiment, the thickness of the dielectric layer 30 can be from about 20 nm to about 100 nm. In some embodiments, the dielectric layer can be deposited using techniques, such as LPCVD, PECVD, ALD etc.

In one embodiment, the layers forming the protrusions 20, the dielectric layer 30, the metal pattern 40 and the transparent heat-conducting layer 50 are then patterned and etched using standard photolithographic processes to form the heat radiating pattern as shown in FIG. 5.

In one embodiment, the heat radiating pattern can be used in a process for imprint lithography. The heat radiating pattern is formed as described above into a desired imprint pattern. The imprinting process includes providing a surface to be imprinted, radiating heat from the heat-radiating pattern, and applying the heat-radiating pattern to the surface to be imprinted. The heat 95 (of FIG. 3B) can be radiated by applying light to the heat-radiating pattern as previously described. In some embodiments, the heat 95 radiating from the heat-radiating pattern can improve the imprinting by rendering the surface to be imprinted more pliable.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A heat-radiating pattern, comprising:
a dielectric substrate;
a metal layer including one or more metal nanoparticles, the metal layer forming an interface with the substrate in a pattern above the substrate and configured to radiate heat after light is applied; and
a heat-conducting layer on top of the metal layer.

2. The heat-radiating pattern of claim 1, further comprising a heat insulating material on a portion of the substrate not covered by the metal layer.

3. The heat-radiating pattern of claim 2, wherein the heat insulating material extends from the substrate to a height the same or less than that of the heat conducting layer.

4. The heat-radiating pattern of claim 2, wherein the heat insulating material comprises metal oxide.

5. The heat-radiating pattern of claim 2, wherein the heat insulating material comprises magnesium oxide or zinc oxide.

6. The heat-radiating pattern of claim 1, wherein the metal layer comprises Au or Ag.

7. The heat-radiating pattern of claim 1, wherein a thickness of the metal layer is within a range of about 2 nm to about 20 nm.

8. The heat-radiating pattern of claim 1, wherein the heat-conducting layer is configured to be transparent to light in IR range.

9. The heat-radiating pattern of claim 1, wherein the heat-conducting layer comprises doped metal oxide.

10. The heat-radiating pattern of claim 9, wherein the heat-conducting layer comprises ITO or F-doped SnO₂.

11. The heat-radiating pattern of claim 1, wherein a thickness of the heat-conducting layer is within a range of about 20 nm to about 50 nm.

12. The heat-radiating pattern of claim 1, wherein the dielectric substrate is formed of a dielectric material.

13. The heat-radiating pattern of claim 1, wherein the dielectric substrate comprises a non-dielectric material coated with dielectric material.

14. The heat-radiating pattern of claim 1, further comprising:
a plurality of protrusions on top of the substrate and below the metal layer; and
a dielectric layer interposed between the plurality of protrusions and the metal layer.

15. The heat-radiating pattern of 14, wherein the protrusions comprise height from about 100 nm to about 500 nm and a length from about 50 nm to about 200 nm.

16. The heat-radiating pattern of 14, wherein the dielectric layer comprises SiO₂.

17. The heat-radiating pattern of 14, wherein a thickness of the dielectric layer is within a range of about 20 nm to about 100 nm.

18. The heat-radiating pattern of claim 1, further comprising an optical fiber configured to provide light to the metal layer.

19. A method of radiating heat in a pattern, comprising applying light to a heat-radiating pattern according to claim 1 so as to radiate heat therefrom.

20. The method of claim 19, wherein applying light comprises emitting light in IR region.

21. The method of claim 20, wherein applying light comprises applying light with a laser of wavelength from about 500 nm to about 1400 nm.

22. The method of claim 20, wherein the laser comprises intensity from about 10 W/cm² to about 20 W/cm².

23. The method of claim 20, wherein the laser is applied for a time from about 3 minutes to about 60 minutes.

24. The method of claim 20, wherein the heat-radiating pattern is in an environment having a surrounding temperature, and wherein responsive to the applied light the heat-radiating pattern radiates heat at a temperature of from about 30° C. to about 100° C. above the surrounding temperature.

25. A method of forming a heat-radiating pattern according to claim 2, the method further comprising:
polishing a surface of the heat-conducting layer and a surface of the heat insulating material to form a polished surface; and
applying a polymer layer on the polished surface.

26. The method of claim 25, further comprising curing a portion of the polymer layer by illuminating the interface to cause heat to be radiated from the metal layer.

27. The method of claim 25, further comprising melting a portion of the polymer layer by illuminated the interface to cause heat to be radiated from the metal layer.

28. A method of denaturing DNA, comprising:
forming a micro-well on a heat-radiating structure according to claim 1;
inserting a sample of DNA into the micro-well; and
radiating heat to the sample of DNA from the heat-radiating pattern so as to denature the sample of DNA.

29. The method according to claim 28, wherein the heat is radiated by applying light to the interface.

30. A process for imprint lithography, comprising:
applying a heat-radiating structure according to claim 14 to a surface to be imprinted; and
illuminating the interface to cause heat to be radiated from the metal layer.
